(19) United States
(12) Patent Application Publication
(10) Pub. No.: US 2022/0092881 A1
(43) Pub. Date: Mar. 24, 2022

(54) METHOD AND APPARATUS FOR BEHAVIOR ANALYSIS, ELECTRONIC APPARATUS, STORAGE MEDIUM, AND COMPUTER PROGRAM

(71) Applicant: SHENZHEN SENSETIME TECHNOLOGY CO., LTD., Shenzhen (CN)

(72) Inventors: Xiaoying HUANG, Shenzhen (CN); Weilin LI, Shenzhen (CN); Xiaotong LI, Shenzhen (CN)

(21) Appl. No.: 17/542,904

(22) Filed: Dec. 6, 2021

Related U.S. Application Data
(63) Continuation of application No. PCT/CN2020/093789, filed on Jun. 1, 2020.

(30) Foreign Application Priority Data
Sep. 30, 2019 (CN) 201910944310.1

(51) Int. Cl. G06V 40/20; G06V 10/25; G06V 10/762; G06V 40/16

(52) U.S. Cl. CPC G06V 40/20; G06V 40/166; G06V 10/762; G06V 10/25

(57) ABSTRACT

A method for behavior analysis includes: obtaining the profile information of a target object, where the profile information includes personal information of the target object, at least one captured image of the target object and image capturing information of the captured image, where the image capturing information includes a capture location; obtaining information of one or more Points of Interest (POIs) of a surrounding area of the capture location based on map data, where the surrounding area represents a preset geographic area including the capture location; and obtaining behavior data of the target object based on the information of the POIs and the profile information of the target object.

### CROSS-REFERENCE TO RELATED APPLICATIONS

This application is a continuation of International Application No. PCT/CN2020/093789, filed on Jun. 1, 2020, which claims the priority of Chinese Patent Application No. 201910944310.1, filed on Sep. 30, 2019. The disclosures of International Application No. PCT/CN2020/093789 and Chinese Patent Application No. 201910944310.1 are hereby incorporated by reference in their entireties.

### BACKGROUND

Traditional case investigation methods are often based on a certain case that has occurred. A suspect and an identity of the suspect are identified by searching for relevant clues, and whereabouts of the suspect are tracked at the same time, so as to solve the case. However, the above-mentioned “case-to-person” investigation method can only be carried out after the case occurred.

Furthermore, the public security organs currently manage and control people mainly by manually viewing video surveillance data or regularly checking key places and people, which is difficult to implement and requires a lot of human resources and time costs. How to manage and control people intelligently before the case occurs and prevent crimes is an urgent problem need to be solved in management of public safety.

### SUMMARY

The embodiments of the present disclosure relate to the technical field of computer vision, and relate to, but are not limited to, a method and an apparatus for behavior analysis, an electronic device, a computer storage medium, and a computer program.

The embodiments of the present disclosure are intended to provide a method and an apparatus for behavior analysis, an electronic device, a computer storage medium and a computer program.

The embodiments of the present disclosure provide a method for behavior analysis, including: obtaining profile information of a target object, herein the profile information includes personal information of the target object, at least one captured image of the target object and image capturing information of the captured image, herein the image capturing information includes a capture location; obtaining information of one or more Points of Interest (POIs) of a surrounding area of the capture location based on map data, herein the surrounding area represents a preset geographic area including the capture location; and obtaining behavior data of the target object based on the information of the POIs and the profile information of the target object.

The embodiments of the present disclosure provide an apparatus for behavior analysis. The apparatus includes a memory storing processor-executable instructions; and a processor configured to execute the stored processor-executable instructions to perform operations of: obtaining profile information of a target object, wherein the profile information comprises personal information of the target object, at least one captured image of the target object and image capturing information of the captured image, wherein the image capturing information comprises a capture location; obtaining information of one or more Points of Interest (POIs) of a surrounding area of the capture location based on map data, wherein the surrounding area represents a preset geographic area including the capture location; and obtaining behavior data of the target object based on the information of the POIs and the profile information of the target object.

The embodiments of the present disclosure provide a non-transitory computer-readable storage medium having stored thereon computer-readable instructions that, when executed by a processor, cause the processor to perform a method for behavior analysis, the method including: obtaining profile information of a target object, wherein the profile information comprises personal information of the target object, at least one captured image of the target object and image capturing information of the captured image, wherein the image capturing information comprises a capture location; obtaining information of one or more Points of Interest (POIs) of a surrounding area of the capture location based on map data, wherein the surrounding area represents a preset geographic area including the capture location; and obtaining behavior data of the target object based on the information of the POIs and the profile information of the target object.

It should be understood that the above general description and the following detailed description are only exemplary and explanatory, rather than limiting the present disclosure.

### BRIEF DESCRIPTION OF THE DRAWINGS

The drawings herein are incorporated into the specification and constitute a part of the specification. These drawings illustrate embodiments that conform to the present disclosure and are used together with the specification to illustrate the technical solutions of the embodiments of the present disclosure.

FIG. 1 is a flowchart of a method for behavior analysis according to an embodiment of the present disclosure.

FIG. 2 is a schematic diagram of an application scenario according to an embodiment of the present disclosure.

FIG. 3 is a schematic diagram of a composition structure of an apparatus for behavior analysis according to an embodiment of the present disclosure.

FIG. 4 is a schematic structural diagram of an electronic device according to an embodiment of the present disclosure.

### DETAILED DESCRIPTION

The present disclosure will be further described in detail below in conjunction with the appended drawings and embodiments. It should be understood that the embodiments provided herein are only used to explain the present disclosure, but are not used to limit the present disclosure. In addition, the embodiments provided below are part of the embodiments for implementing the present disclosure, not all the embodiments for implementing the present disclosure are provided. In the case of no conflict, the technical solutions described in the embodiments of the present disclosure can be implemented in any combination.

It should be noted that in the embodiments of the present disclosure, the terms “include”, “include” or any other variants thereof are intended to cover non-exclusive inclusion, so that the method or apparatus including a series of elements not only includes the explicitly recited elements, but further includes other elements that are not explicitly listed, or elements inherent to the implementation of the method or apparatus. Without more restrictions, the element defined by the sentence “including a . . . ” does not exclude the existence of other related elements (such as operations in the method or units in the apparatus, for example, the unit may be part of the circuit, part of the processor, part of the program or software, etc.) in the method or apparatus that includes the element.

For example, the method for behavior analysis provided in the embodiment of the present disclosure includes a series of operations, but the method for behavior analysis provided in the embodiment of the present disclosure is not limited to the recited operations. Similarly, the apparatus for behavior analysis provided in the embodiment of the present disclosure includes a series of modules, but the apparatus provided in the embodiments of the present disclosure is not limited to include the explicitly recited modules, and may further include modules that need to be set to obtain related information or perform processing based on information.

The term “and/or” herein is only an association relationship describing associated objects, which means that there may be three relationships. For example “A and/or B” may have three meanings: A exists alone, A and B exist at the same time and B exists alone. In addition, the term “at least one” in this document means any one situation of multiple situations or any combination of at least two situations of the multiple situations. For example, including at least one of A, B or C, may mean including any one or more elements selected in the set formed by A, B and C.

The embodiments of the present disclosure can be applied to a computer system composed of a terminal and a server, and can be operated with many other general or dedicated computing system environments or configurations. Herein, the terminal can be a thin client, a thick client, a handheld device or a laptop device, a microprocessor-based system, a set-top box, a programmable consumer electronic product, a network personal computer, a small computer system, etc. The server can be a server computer system, a small computer system, a large computer system and distributed cloud computing technology environment including any of the above systems, etc.

Electronic devices such as terminals and servers can be described in the general context of computer system executable instructions (such as program modules) executed by a computer system. Generally, program modules may include routines, programs, object programs, components, logic, data structures, etc., which perform specific tasks or implement specific abstract data types. The computer system/server can be implemented in a distributed cloud computing environment. In the distributed cloud computing environment, tasks are executed by remote processing device linked through a communication network. In a distributed cloud computing environment, program modules may be located on storage media of local or remote computing systems including storage devices.

In some embodiments of the present disclosure, a method for behavior analysis is proposed, which can be applied to scenarios such as intelligent video analysis, security monitoring and big data analysis.

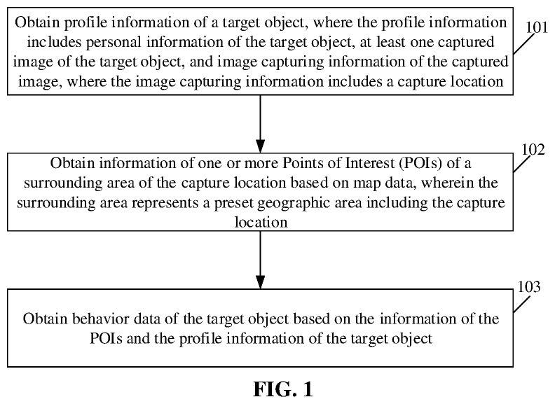

FIG. 1 is a flowchart of a method for behavior analysis according to an embodiment of the present disclosure. As shown in FIG. 1, the process may include the following operations.

In operation 101, profile information of a target object is obtained, herein the profile information includes personal information of the target object, at least one captured image of the target object, and image capturing information of the captured image, herein the image capturing information includes a capture location.

In the embodiments of the present disclosure, the target object may be a predetermined person to be monitored. In some embodiments of the present disclosure, the personal information of the target object may include at least one of a facial feature of the target object, a human body feature of the target object, a motor vehicle feature of the target object, a non-motor vehicle feature of the target object or identity information of the target object. For example, the identity information of the target object may be the information such as the facial feature of the target object, the facial image of the target object and an identity card number of the target object. In practical applications, the facial feature of the target object can be extracted from the facial image of the target object.

In some embodiments of the present disclosure, the personal information of the target object may be obtained from a fugitive information database and a criminal offender information database, and the personal information of the target object may be stored in a management-and-control people database. Herein, there may be one or multiple target objects.

In practical applications, the captured image of the target object can be collected by a monitoring device. The monitoring device can be a device used to collect images such as an image capturing device, or a device used to capture videos such as a camera. The number of monitoring device can be one or multiple. In some embodiments of the present disclosure, the monitoring device may be a monitoring device constructed by a public security organ.

In practical applications, when the monitoring device is a device for collecting videos, the collected videos can be decoded, and then at least one image (at least one frame of image) can be extracted from the decoded video stream.

Herein, the capture location represents location information of a monitoring device, and the location information of the monitoring device can be represented by latitude and longitude. In some embodiments of the present disclosure, the image capturing information may further include the capture time which represents the time point when the monitoring device collects the image.

In practical applications, when the monitoring device collects at least one image, at least one captured image of the target object can be determined from the at least one image collected by the monitoring device; and the capture time and the capture location of each image collected by the monitoring device can be determined; therefore, the image capturing information of the captured image of the target object can be determined. In one example, after obtaining the captured image of the target object and the image capturing information of the captured image, the captured image of the target object and the image capturing information of the captured image may be associated, and the associated data may be stored in a capture database.

Regarding the implementation of obtaining the profile information of the target object, in one example at least one group of clustering results is obtained by clustering each captured image obtained and the image capturing information of each captured image using a target feature as a basis for clustering.

In some embodiments of the present disclosure, the target feature may include at least one of a facial feature, a human body feature, a motor vehicle feature, or a non-motor vehicle feature. In actual implementation, a target recognition method based on deep learning may be used to perform target recognition on the images collected by the monitoring device to obtain the target feature. In the embodiment of the present disclosure, the target recognition method adopted is not limited.

In the embodiment of the present disclosure, the target feature (the facial feature, the human body feature, the motor vehicle feature, or the non-motor vehicle feature) includes data in two dimensions: a feature value and a feature attribute. The feature value is used for feature matching. For example, a feature value can be compared with M feature values, herein M can be an integer greater than or equal to 1 and the M feature values can be pre-stored feature values. The feature attribute is used to represent the attribute of the target feature. Illustratively, the human body feature is used to represent at least one of: a gender, an age, a beard type, a hairstyle, a top and bottom clothing style or a top and bottom clothing color; the motor vehicle feature is used to represent at least one of one: a motor vehicle type, a license plate number, a motor vehicle shape or a motor vehicle size; the non-motor vehicle feature is used to represent at least one of: a non-motor vehicle type, a non-motor vehicle shape or a non-motor vehicle size. In practical applications, the feature attribute facilitates subsequent data filtering based on the target feature. For example, after determining the physical feature of the suspicious person, the images collected by the monitoring device can be filtered according to the human physical feature in the feature attribute.

In some embodiments of the present disclosure, after performing target recognition on the image collected by the monitoring device, the target feature of the same object can be obtained by associating the target feature in the same location area according to the position of the human body, the human face, the motor vehicle, and the non-motor vehicle in an image.

Herein, each captured image represents each image collected by the monitoring device, and any one of the captured images may include or not include the target object. It can be seen that, using the target feature as the basis for clustering, by clustering each captured image obtained and image capturing information of each captured image, the target feature of the same person can be aggregated. In actual implementation, after at least one group of clustering results is obtained through clustering, the above at least one group of clustering results can be stored in a cluster database.

After obtaining at least one group of clustering results, the profile information of the target object is obtained by associating each of the above at least one group of clustering results with personal information of the predetermined target object. In some embodiments of the present disclosure, the matching of each of the above at least one group of clustering results with the personal information of the predetermined target object may be performed based on the target feature, to obtain the captured images and the image capturing information corresponding to the target feature that matches successfully, and the personal information of the target object corresponding to the target feature that matches successfully. When the matching of each of the above at least one group of clustering results with the personal information of the predetermined target object is performed based on the target feature, if the similarity of the target feature exceeds the set similarity threshold, the matching can be considered successful, otherwise, if the similarity of the target feature does not exceed the set similarity threshold, the matching can be considered failed. The similarity threshold can be set according to actual application scenarios. For example, the set similarity threshold can be 90%, 95% and so on.

It can be understood that, by clustering the captured images obtained and the image capturing information of each captured image, the target feature of the same person can be aggregated, in order to facilitate the subsequent matching of the target feature to quickly obtain the profile information of the same target object.

Regarding the implementation of obtaining the profile information of the target object, in some embodiments of the present disclosure, after obtaining each captured image collected by the monitoring device, the image capturing information of each captured image, and the personal information of the predetermined target object, the profile information of the target object is obtained by directly using the target feature as a basis for clustering and then clustering each captured image obtained, the image capturing information of each captured image and the personal information of the predetermined target object.

It can be seen that, by clustering each captured image, the image capturing information of each captured image and the personal information of the predetermined target object, the profile information of the target object can be directly obtained, which is easy to implement.

In practical applications, after obtaining the profile information of the target object, the profile information of the target object can be stored in a database of people's profiles.

In operation 102, information of one or more Points of Interest (POIs) of a surrounding area of the capture location is obtained based on map data, herein the surrounding area represents a preset geographic area including the capture location.

Exemplarily, the surrounding area of the capture location can be an area with the capture location as the center and a set distance as the radius. The set distance can be set according to the actual application scenario, for example, the set distance is 100m, 150m, 50m, etc.

Herein, the information of the POIs may be preset information. For example, the POIs may be a hospital, a residential community, a hotel, a railway station, etc. There may be one or more POIs in the surrounding area of the capture location.

Furthermore, it is also possible to add a label of location type to the corresponding monitoring device according to the information of the POIs of the surrounding area of the capture location. In this way, after the images collected by the monitoring device are obtained, the label of location type of the monitoring device can be obtained for subsequent analysis. For example, if there are information of three POIs of railway station, hotel and restaurant within 100 m of a monitoring device D, three labels of railway station, hotel and restaurant are added to the monitoring device D.

In operation 103, behavior data of the target object is obtained based on the information of the POIs and the profile information of the target object.

In the embodiments of the present disclosure, the behavior data of the target object may represent the behavior pattern of the target object and/or the category information of the target object. For example, the behavior pattern of the target object may represent the number of appearance of the target object at the POIs and the appearance time of the target object at the POIs. The category information of the target object can indicate which type of person the target object belongs to that needs to be monitored. For example, the category information of the target object can indicate that the target object belongs to a professional medical dispute causer or a ticket scalper. In practical applications, the historical activity trajectory of the target object can be determined according to the profile information of the target object. Herein, the historical activity trajectory of the target object can indicate the appearance time and/or appearance location of the target object. After obtaining the historical activity trajectory of the target object, the behavior data of the target object can be obtained according to the historical activity trajectory and information of the POIs of the target object.

The implementation of this operation is exemplified below.

In a first example, the POIs include a first POI. In this case, a first number of captures for the captured image of the target object at the first POI is obtained, and in a case that the first number of captures is greater than or equal to a first preset threshold, it is determined that the first POI is a first preset location of the target object.

Herein, the first POI may be a preset POI. For example, the first POI may be a hospital, a residential community, a hotel or a railway station.

After obtaining the profile information of the target object, the first POI in the surrounding area of the capture location can be found according to the capture location. Furthermore, the captured image of the first POI can be obtained, and through analyzing the captured image of the first POI, the first number of captures of captured image of the target object at the first POI can be obtained.

In the embodiment of the present disclosure, the first preset threshold may be set according to actual application scenarios. In addition, in a case that the first number of captures is less than the first preset threshold, the captured image of the target object at the first POI can be ignored.

It can be understood that, in the case that the first number of captures is greater than or equal to the first preset threshold, it means that the target object often appears at the first POI. Then, taking the first POI as the first preset location of the target object is conducive to the further analysis of the behavior pattern of the target object.

In the embodiment of the present disclosure, the first preset location includes but is not limited to a residence, a workplace, and a location where a target object frequently appears.

Two examples below are described for further details.

In a first example, according to the profile information of a person E, the activity trajectory of the person E in a designated area (such as city of Shenzhen) is counted, and time and location of the person E appearing in office buildings and office areas are determined, and the numbers of times that the person E is captured in different office buildings and office areas are counted, the numbers of times that the person E is captured are sorted in a descending order. When the number of times that the person E is captured exceeds the first preset threshold, it can be determined that the corresponding office building or office area is the suspected workplace of person E. For example, the first preset threshold is set to 80, the person E appears 100 times in office building 1, 10 times in office building 2, and 8 times in office building 3, then the suspected workplace of the person E is office building 1.

In a second example, according to the profile data of a person F who committed a burglary, the time and location of the person F who committed a burglary appearing in a designated area (such as city of Shenzhen) within a designated time period (such as the last month) are counted, the time and location of the person F who committed a burglary appearing in the residential community is determined, and the numbers of times that the person F is captured in different residential communities is counted, the numbers of times that the person F is captured is sorted in a descending order. In a case that a residential community of the person F who committed a burglary is known, excluding the residential community of the person F who committed a burglary, then, when the number of times that the person F is captured exceeds the first preset threshold, it can be determined that the corresponding community is a place suspected to be a scouting place of the person F who committed a burglary. For example, the first a preset threshold is set to 5, the person F who committed a burglary appears 30 times in community 1, 10 times in community 2, 8 times in community 3, and 1 time in community 4. It is known that the community 1 is the residential community of the person F who committed a burglary, then it can be obtained that community 2 and community 3 are the place suspected to be a scouting place of the person F who committed a burglary.

In the second example, the image capturing information further includes the capture time, and the POIs include a second POI. In this case, the capture time and the second number of captures for the captured image of the target object at the second POI are obtained, and in a case that the capture time is within a preset time range and the second number of captures is greater than or equal to a second preset threshold, it is determined that the second POI is a second preset location of the target object.

Herein, the second POI may be a preset POI. For example, the second POI may be a hospital, a residential community, a hotel, or a railway station.

After obtaining the profile information of the target object, the second POI in the surrounding area of the capture location can be found according to the capture location. Furthermore, the captured image of the second POI can be obtained, and through analyzing the captured image of the second POI, the capture time and the second number of captures of captured image of the target object at the second POI can be obtained.

In the embodiment of the present disclosure, the second preset threshold may be set according to actual application scenarios. In addition, in a case that the capture time of is not within the preset time range or the second number of captures is less than the second preset threshold, the captured image of the target object at the second POI can be ignored.

It can be understood that, when the capture time is within the preset time range and the second number of captures is greater than or equal to the second preset threshold, it means that the target object often appears at the second POI within the preset time range. Then, taking the second POI as the second preset location of the target object is conducive to the further analysis of the behavior pattern of the target object.

In the embodiment of the present disclosure, the second preset location includes but is not limited to an analyzed residence, a workplace, and a location where a target object frequently appears.

In some embodiments of the present disclosure, the second POI is office building 4, the preset time range is from 9 am to 6 pm. When the number of times that a person G is captured within the preset time range is greater than or equal to the second preset threshold, it means that the workplace of the person G is office building 4, that is, the second preset location is office building 4. For example, the second preset threshold is 60, and the number of times that the person G is captured within the preset time range is 77, then it means that the workplace of the person G is office building 4.

In some embodiments of the present disclosure, the second POI is community 5, the preset time range is from 8 pm to 7 am at the next morning. In the case that the number of times that a person H is captured within the preset time range is greater than or equal to the second preset threshold, it means that the residential community of the person H is community 5, that is, the second preset location is community 5. For example, the second preset threshold is 80, and the number of times that the person H is captured within the preset time range is 88, then it means that the residential community of person H is community 5.

In a third example, the POIs include a third POI. Then, in a case that the category of the profile information of the target object is a first library category, and a third number of captures of captured image of the target object at a third POI is greater than or equal to a third preset threshold, it is determined that the target object is a preset target object.

Herein, the third POI may be a preset POI. For example, the third POI may be a hospital, a residential community, a hotel, or a train station, etc. The first library category may be a category of predetermined profile information. For example, a first library category can represent a database for people who have criminal records, a database for management-and-control people, etc. The management-and-control people refer to those who need to be monitored. The management-and-control people can be a professional medical disputer causer, a ticket scalper, people who handle stolen goods, and people who committed a burglary, etc. In practical applications, through analyzing the personal information in the profile information of the target object, the category of the profile information of the target object can be obtained.

After obtaining the profile information of the target object, the third POI in the surrounding area of the capture location can be found according to the capture location, and then the captured image of the third POI can be obtained, and through analyzing the captured image of the third POI, the third number of captures for the captured image of the target object at the third POI can be obtained.

In the embodiment of the present disclosure, the third preset threshold may be set according to actual application scenarios. In addition, in the case that the category of the target object is not a first library category, or the third number of captures for the captured image of the third POI is less than a third preset threshold, the captured image of the target object at the third POI can be ignored.

It can be understood that, in the case that the third number of captures for the captured image of the target object at the third POI is greater than or equal to the third preset threshold, it means that the target object often appears at the third POI. On this basis, if the category of the profile information of the target object is the first library category, and the category of the target object can be directly determined. Furthermore, by determining that the target object is a preset target object, it is beneficial to further analyze the behavior pattern of the target object.

In the embodiment of the present disclosure, the preset target objects include, but are not limited to, a professional medical disputer causer, a ticket scalper, people who handle stolen goods, and people who committed a burglary, etc.

In some embodiments of the present disclosure, the third POI is a hospital P, and the first database category is a database of management-and-control people. According to the profile information of a person Q, it is determined that the label of location type in the specified time period (such as the last 3 months) is the captured images of the hospital P and the number of times that the person Q is captured in the hospital P is counted. When the number of times that the person Q is captured in the hospital P exceeds the third preset threshold, it can be determined that the person Q is a ticket scalper in the hospital P.

In practical applications, operations 101 to 103 can be implemented by utilizing the processor in the apparatus for behavior analysis. The apparatus for behavior analysis mentioned above can be User Equipment (UE), a mobile device, a user terminal, a terminal, a cell phone, a cordless phone, a personal digital assistant (PDA), a handheld device, a computing device, a vehicle-mounted device, a wearable device, etc. The above-mentioned processors can be at least one of application specific integrated circuits (ASIC), digital signal processors (DSP), digital signal processing devices (DSPD), programmable logic devices (PLD), field-programmable gate arrays (FPGA), central processing units (CPU), controllers, microcontrollers or microprocessors.

In the embodiment of the present disclosure, the target object can be analyzed according to the profile information of the target object and the information of the POIs of the surrounding area of the capture location. That is to say, in the embodiment of the present disclosure, there is no need to search for the whereabouts of the target object after the case occurs, but the behavior of the target object can be analyzed in advance, which is beneficial to manage and control the target object according to the behavior data of the target object before the case occurs.

In some embodiments of the present disclosure, after obtaining the behavior data of the target object, an early warning condition can be determined according to the behavior data of the target object, herein the early warning condition represents a condition of a person exhibiting abnormal behaviors, and responsive to that the behavior data of the target object is obtained again and the behavior data of the target object obtained again meets the predetermined condition, early warning information is generated.

In some embodiments of the present disclosure, the behavior pattern of the target object can be determined according to the behavior data of the target object, and then the early warning condition can be determined. For example, the early warning condition may be that an illegal petitioner appears at a train station within a specified time period, people who stolen an electric motor before and people who handle stolen goods appear in a second-hand electric vehicle market at the same time. If the behavior data of the target object meets the early warning condition, early warning information can be generated to promptly notify the police of the public security organ to pay attention to relevant information.

It can be seen that the embodiment of the present disclosure can provide early warning of abnormal behavior of people according to the early warning conditions.

The embodiments of the present disclosure can be applied to scenarios that require people management and control. For example, in a hospital scenario, professional medical disputer causer can be identified, and behaviors such as the appearance and gathering of professional medical disputer causer can be identified, so as to realize the management and control of professional medical disputer causer.

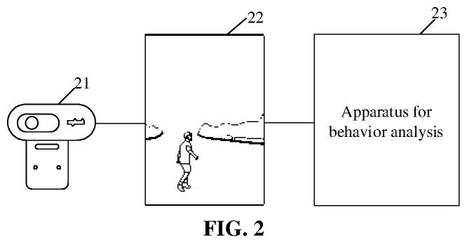

FIG. 2 is a schematic diagram of an application scenario according to an embodiment of the present disclosure. As shown in FIG. 2, the captured image 22 can be obtained by a capture machine 21. Herein, the human body in the captured image 22 is the target object. Then, the captured image 22 can be input to the above-mentioned apparatus for behavior analysis 23. In the apparatus for behavior analysis 23, through the method for behavior analysis described in the foregoing embodiment, the behavior data of the target object can be obtained, for example, the behavior pattern of a certain person can be obtained. It should be noted that the scenario shown in FIG. 2 is only an exemplary scenario according to an embodiment of the present disclosure, and the present disclosure does not limit specific application scenarios.

Those skilled in the art can understand that in the above-mentioned method of the specific implementation, the writing order of the operations does not mean a strict execution order that constitutes any limitation on the implementation process. The specific execution order of each operation should be determined based on its function and possible internal logic.

On the basis of the method for behavior analysis proposed in the foregoing embodiment, an embodiment of the present disclosure proposes an apparatus for behavior analysis.

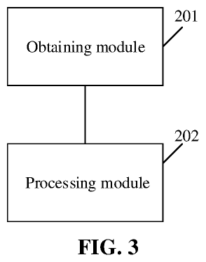

FIG. 3 is a schematic diagram of a composition structure of an apparatus for behavior analysis according to an embodiment of the present disclosure. As shown in FIG. 3, the apparatus includes an obtaining module 201 and a processing module 202.

The obtaining module 201 is configured to obtain profile information of a target object, herein, the profile information includes personal information of the target object, at least one captured image of the target object and image capturing information of the captured image, herein, the image capturing information includes a capture location.

The processing module 202 is configured to: obtain information of the POIs of the surrounding area of the capture location based on map data, herein the surrounding area represents a preset geographic area including the capture location, and obtain behavior data of the target object based on the information of the POIs and the profile information of the target object.

In some embodiments of the present disclosure, the POIs include a first POI, and the processing module 202 is configured to obtain a first number of captures for the captured image of the target object at the first POI, and in a case that the first number of captures is greater than or equal to a first preset threshold, determine that the first POI is a first preset location of the target object.

In some embodiments of the present disclosure, the image capturing information further includes capture time, the POIs include a second POI, and the processing module 202 is configured to obtain the capture time and the second number of captures for the captured image of the target object at the second POI, and in a case that the capture time is within a preset time range and the second number of captures is greater than or equal to a second preset threshold, determine that the second POI is a second preset location of the target object.

In some embodiments of the present disclosure, the POIs include a third POI, and the processing module 202 is configured to: in a case that a category of the profile information of the target object is a first library category, and a third number of captures for the captured image of the target object at the third POI is greater than or equal to a third preset threshold, determine that the target object is a preset target object.

In some embodiments of the present disclosure, the personal information of the target object includes identity information of the target object.

In some embodiments of the present disclosure, the obtaining module 201 is configured to obtain at least one group of clustering results by clustering each captured image obtained and the image capturing information of each captured image using a target feature as a basis for clustering, and obtain the profile information of the target object by associating each of the at least one group of clustering results with personal information of the predetermined target object.

In some embodiments of the present disclosure, the obtaining module 201 is configured to obtain profile information of the target object by clustering each captured image obtained, the image capturing information of each captured image and the personal information of the predetermined target object using a target feature as a basis for clustering.

In some embodiments of the present disclosure, the target feature includes at least one of: a facial feature, a human body feature, a motor vehicle feature or a non-motor vehicle feature.

In some embodiments of the present disclosure, the processing module 202 is further configured to determine an early warning condition according to the behavior data of the target object, herein the early warning condition represents a condition of a person exhibiting abnormal behaviors, and responsive to that the behavior data of the target object is obtained again and the behavior data of the target object obtained again meets the early warning condition, generate early warning information.

In practical applications, both the obtaining module 201 and the processing module 202 can be implemented by utilizing a processor in an electronic device. The processor can be at least one of an ASIC, a DSP, a DSPD, a PLD, a FPGA, a CPU, a controller, a microcontroller or a microprocessor.

In addition, the functional modules in this embodiment may be integrated into one processing unit, or each unit may exist separately and physically, or two or more units may be integrated into one unit. The integrated unit can be realized in the form of hardware or software function modules.

If the integrated unit is implemented in the form of a software functional unit and not sold or used as an independent product, it can be stored in a computer readable storage medium. Based on this understanding, the technical solutions of the embodiments of the present disclosure or the part that contributes to the prior art or the part of the technical solutions can be essentially embodied in the form of a software product, and the computer software product is stored in a storage medium including several instructions to cause a computer device (which can be a personal computer, a server, or a network device, etc.) to execute all or part of the operations of the method described in the embodiments of the present disclosure. The aforementioned storage medium may be various media that can store program codes, such as: a U disk, a mobile hard disk, a read-only memory, a random access memory, a magnetic disk and an optical disk.

Specifically, the computer program instructions corresponding to a method for behavior analysis in this embodiment can be stored on storage media such as optical disks, hard disks, and U disks. When the computer program instructions corresponding to another method for behavior analysis in the storage medium are read or executed by an electronic device, any one of the method for behavior analysis according to the foregoing embodiments is implemented.

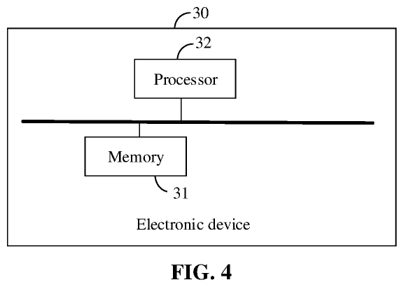

Based on the same technical concept of the foregoing embodiment, refer to FIG. 4, which shows an electronic device 30 provided by an embodiment of the present disclosure, the electronic device 30 includes a memory 31 and a processor 32.

The memory 31 is configured to store computer programs and data.

The processor 32 is configured to execute computer programs stored in the memory to implement any method for behavior analysis according to the foregoing embodiments.

In practical applications, the aforementioned memory 31 may be a volatile memory, such as an RAM; or a non-volatile memory, such as an ROM, a flash memory, a hard disk or a solid-state drive (SSD); or a combination of the above types of memory, and the memory 31 may provide instructions and data to the processor 32.

The aforementioned processor 32 may be at least one of an ASIC, a DSP, a DSPD, a PLD, a FPGA, a CPU, a controller, a microcontroller or a microprocessor. It is understood that, for different devices, there may be other electronic devices used to implement the functions of the above-mentioned processor, which is not specifically limited in the embodiment of the present disclosure.

In some embodiments, the functions owned by or modules contained in the apparatus provided in the embodiments of the present disclosure can be used to implement the methods described in the above method embodiments. For specific implementation, the description of the above method embodiments can be referred to. For the sake of brevity, details will not be repeated herein.

The above description on the various embodiments tends to emphasize the differences among the various embodiments, the same or similarities of which can be referred mutually. For the sake of brevity, details will not be repeated herein.

The methods disclosed in the method embodiments provided in the present disclosure can be combined arbitrarily without conflict to obtain new method embodiments.

The feature disclosed in the product embodiments provided in the present disclosure can be combined arbitrarily without conflict to obtain new product embodiments.

The feature disclosed in each method or device embodiment provided in the present disclosure can be combined arbitrarily without conflict to obtain new method embodiments or device embodiments.

Through the description of the above embodiments, those skilled in the art can clearly understand that the method of the above embodiments can be implemented by means of software plus the necessary general hardware platform. Of course, it can also be implemented by hardware, but in many cases the former is a better implementation. Based on such an understanding, the technical solution of the present invention or the part that contributes to the prior art essentially can be embodied in the form of a software product, and the computer software product is stored in a storage medium (such as an ROM/RAM, a magnetic disk, an optical disk) and includes several instructions to cause a terminal (which can be a mobile phone, a computer, a server, an air conditioner, or a network device, etc.) to implement the method described in each embodiment of the present invention.

The embodiments of the present invention are described above with reference to the appended drawings, but the present invention is not limited to the above-mentioned specific embodiments. The above-mentioned specific embodiments are only illustrative but not restrictive. Under the enlightenment of the present invention, those of ordinary skill in the art may make embodiments of many forms without departing from the purpose of the present invention and the protection scope of the claims, and these are all within the protection of the present invention.

### INDUSTRIAL APPLICABILITY

The embodiments of the present disclosure provide a method and an apparatus for behavior analysis, an electronic device, a computer storage medium, and computer programs. The method includes: obtaining profile information of a target object, herein, the profile information includes personal information of the target object, at least one captured image of the target object and image capturing information of the captured image, herein, the image capturing information includes a capture location; obtaining information of one or more POIs of a surrounding area of the capture location based on map data, herein the surrounding area represents a preset geographic area including the capture location; and obtaining behavior data of the target object based on the information of the POIs and the profile information of the target object. In this way, there is no need to search for the whereabouts of the target object after the case occurs, but the behavior of the target object can be analyzed in advance, which is beneficial to manage and control the target object according to the behavior data of the target object before the case occurs.

1. A method for behavior analysis, comprising:
obtaining profile information of a target object, wherein the profile information comprises personal information of the target object, at least one captured image of the target object and image capturing information of the captured image, wherein the image capturing information comprises a capture location;
obtaining information of one or more Points of Interest (POIs) of a surrounding area of the capture location based on map data, wherein the surrounding area represents a preset geographic area including the capture location; and
obtaining behavior data of the target object based on the information of the POIs and the profile information of the target object.

2. The method of claim 1, wherein the POIs comprise a first POI, and obtaining the behavior data of the target object based on the information of the POIs and the profile information of the target object comprises:
obtaining a first number of times of captures for the captured image of the target object at the first POI; and
in a case that the first number of times of captures is greater than or equal to a first preset threshold, determining that the first POI is a first preset location of the target object.

3. The method of claim 1, wherein the image capturing information further comprises a capture time, the POIs comprise a second POI, and obtaining the behavior data of the target object based on the information of the POIs and the profile information of the target object comprises:
obtaining a capture time and a second number of times of captures for the captured image of the target object at the second POI; and
in a case that the capture time is within a preset time range and the second number of times of captures is greater than or equal to a second preset threshold, determining that the second POI is a second preset location of the target object.

4. The method of claim 1, wherein the POIs comprise a third POI, and obtaining the behavior data of the target object based on the information of the POIs and the profile information of the target object comprises:
in a case that a category of the profile information of the target object is a first library category, and a third number of times of captures for the captured image of the target object at the third POI is greater than or equal to a third preset threshold, determining that the target object is a preset target object.

5. The method of claim 1, wherein the personal information of the target object comprises identity information of the target object.

6. The method of claim 1, wherein obtaining the profile information of the target object comprises:
obtaining at least one group of clustering results by clustering each captured image obtained and the image capturing information of each captured image using a target feature as a basis for clustering; and
obtaining the profile information of the target object by associating each of the at least one group of clustering results with personal information of a predetermined target object.

7. The method of claim 1, wherein obtaining the profile information of the target object comprises:
obtaining the profile information of the target object by clustering each captured image obtained, the image capturing information of each captured image and personal information of a predetermined target object using a target feature as a basis for clustering.

8. The method of claim 6, wherein the target feature comprises at least one of: a facial feature, a human body feature, a motor vehicle feature or a non-motor vehicle feature.

9. The method of claim 1, further comprising:
determining an early warning condition according to the behavior data of the target object, wherein the early warning condition represents a condition of a person exhibiting abnormal behaviors; and
responsive to that the behavior data of the target object is obtained again and the behavior data of the target object obtained again meets the early warning condition, generating early warning information.

10. An apparatus for behavior analysis, comprising:
a memory storing processor-executable instructions; and
a processor configured to execute the processor-executable instructions to perform operations of:
obtaining profile information of a target object, wherein the profile information comprises personal information of the target object, at least one captured image of the target object and image capturing information of the captured image, wherein the image capturing information comprises a capture location;
obtaining information of one or more Points of Interest (POIs) of a surrounding area of the capture location based on map data, wherein the surrounding area represents a preset geographic area including the capture location; and
obtaining behavior data of the target object based on the information of the POIs and the profile information of the target object.

11. The apparatus of claim 10, wherein the POIs comprise a first POI, and obtaining the behavior data of the target object based on the information of the POIs and the profile information of the target object comprises:
obtaining a first number of times of captures for the captured image of the target object at the first POI; and
in a case that the first number of times of captures is greater than or equal to a first preset threshold, determining that the first POI is a first preset location of the target object.

12. The apparatus of claim 10, wherein the image capturing information further comprises a capture time, the POIs comprise a second POI, and obtaining the behavior data of the target object based on the information of the POIs and the profile information of the target object comprises:
obtaining a capture time and a second number of times of captures for the captured image of the target object at the second POI; and
in a case that the capture time is within a preset time range and the second number of times of captures is greater than or equal to a second preset threshold, determining that the second POI is a second preset location of the target object.

13. The apparatus of claim 10, wherein the POIs comprise a third POI, and obtaining the behavior data of the target object based on the information of the POIs and the profile information of the target object comprises:
in a case that a category of the profile information of the target object is a first library category, and a third number of times of captures for the captured image of the target object at the third POI is greater than or equal to a third preset threshold, determining that the target object is a preset target object.

14. The apparatus of claim 10, wherein the personal information of the target object comprises identity information of the target object.

15. The apparatus of claim 10, wherein obtaining the profile information of the target object comprises:
obtaining at least one group of clustering results by clustering each captured image obtained and the image capturing information of each captured image using a target feature as a basis for clustering; and
obtaining the profile information of the target object by associating each of the at least one group of clustering results with personal information of a predetermined target object.

16. The apparatus of claim 10, wherein obtaining the profile information of the target object comprises:
obtaining the profile information of the target object by clustering each captured image obtained, the image capturing information of each captured image and personal information of a predetermined target object using a target feature as a basis for clustering.

17. The apparatus of claim 15, wherein the target feature comprises at least one of: a facial feature, a human body feature, a motor vehicle feature or a non-motor vehicle feature.

18. The apparatus of claim 10, wherein the processor is configured to execute the processor-executable instructions to perform further operations of:
determining an early warning condition according to the behavior data of the target object, wherein the early warning condition represents a condition of a person exhibiting abnormal behaviors; and
responsive to that the behavior data of the target object is obtained again and the behavior data of the target object obtained again meets the early warning condition, generating early warning information.

19. A non-transitory computer-readable storage medium having stored thereon computer-readable instructions that, when executed by a processor, cause the processor to perform a method for behavior analysis, the method comprising:
obtaining profile information of a target object, wherein the profile information comprises personal information of the target object, at least one captured image of the target object and image capturing information of the captured image, wherein the image capturing information comprises a capture location;
obtaining information of one or more Points of Interest (POIs) of a surrounding area of the capture location based on map data, wherein the surrounding area represents a preset geographic area including the capture location; and
obtaining behavior data of the target object based on the information of the POIs and the profile information of the target object.

20. The non-transitory computer-readable storage medium of claim 19, wherein the POIs comprise a first POI, and obtaining the behavior data of the target object based on the information of the POIs and the profile information of the target object comprises:
obtaining a first number of times of captures for the captured image of the target object at the first POI; and
in a case that the first number of times of captures is greater than or equal to a first preset threshold, determining that the first POI is a first preset location of the target object.
